(19) United States
(12) Patent Application Publication
(10) Pub. No.: US 2010/0127413 A1
(43) Pub. Date: May 27, 2010

(54) Method for Manufacturing Plastic Lens

(75) Inventor: Takashi HOSODA, Minamiminowa-mura (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/537,114

(22) Filed: Aug. 6, 2009

(30) Foreign Application Priority Data
Nov. 21, 2008 (JP) 2008-297676

(51) Int. Cl. B29D 11/00

(52) U.S. Cl. 264/2.2

(57) ABSTRACT

A method for manufacturing a plastic lens includes: disposing a pair of plastic lens molding dies in such a way that the dies face each other and are spaced apart from each other by a predetermined distance; forming a frame between the pair of dies; injecting a polymerizable composition into the space surrounded by the frame and the pair of dies; and polymerizing the polymerizable composition in the space to form a plastic lens.

### BACKGROUND

1. Technical Field

The present invention relates to a method for manufacturing a plastic lens.

2. Related Art

In recent years, a lightweight, highly transparent plastic lens has been frequently used as an ophthalmic lens. A typical method for manufacturing an ophthalmic plastic lens includes preparing a pair of molding dies in agreement with the shapes of the surfaces of the lens, one of the surfaces facing the eyeball and the other facing an object, injecting a polymerizable raw material composition into the cavity formed by combining the molding dies, and polymerizing (curing) the composition. This method is called casting polymerization. For example, the method shown in FIGS. 1A and 1B has been known (see JP-A-2006-215217). According to the method, a pair of glass molding dies 11 and 12 is first prepared. They are disposed to face each other and secured by attaching an adhesive tape 4 to the outer circumferential surfaces thereof. Then, a nozzle 5 is inserted into a cavity C surrounded by the molding dies 11, 12 facing each other and the adhesive tape 4, and a polymerizable raw material composition is injected. Thereafter, the raw material composition is polymerized by applying heat or ultraviolet light thereto to form a plastic lens having a predetermined shape. The plastic lens undergoes a hard coat process, anti-reflection process, and a variety of other surface treatments, and is cut into a shape that agrees with an eyeglass frame in what is called an edging process.

However, in the method for manufacturing a plastic lens described above, the cutting operation in the edging process will produce a large amount of cuttings. The polymerized plastic lens is a non-recyclable cross-linked polymer, and the large amount of cuttings cannot be reused but must be discarded. The method described above is therefore problematic in terms of manufacturing cost. A special monomer is often used as a raw material particularly in recent years, as plastic lenses tend to be made of materials having high refractive indices, making the problem of manufacturing cost more serious. Further, discarding a large amount of cuttings is problematic in terms of load on the environment.

### SUMMARY

An advantage of some aspects of the invention is to provide a plastic lens manufacturing method that can reduce the plastic lens manufacturing cost and does not impose a large load on the environment.

A method for manufacturing a plastic lens according to an aspect of the invention includes disposing a pair of plastic lens molding dies in such a way that the dies face each other and are spaced apart from each other by a predetermined distance, forming a frame between the pair of dies, injecting a polymerizable composition into the space surrounded by the frame and the pair of dies, and polymerizing the polymerizable composition in the space to form a plastic lens.

According to the aspect of the invention, since the cavity formed by the pair of lens molding dies has a smaller space surrounded by the dies and the frame, and the polymerizable composition is injected into the space, the necessary amount of polymerizable composition can be significantly reduced. When a hard coat layer, an anti-reflection film, and other films are formed on a surface of the lens, the area to be processed is reduced and the cost is advantageously reduced accordingly.

The reduction in the area to be processed significantly reduces not only the manufacturing cost of the plastic lens but also the amount of cuttings produced in the edging process, whereby the load imposed on the environment can be significantly reduced.

Further, since the frame allows the shape of the space described above to be arbitrarily set, a plastic lens having a desired shape can be readily manufactured. For example, selecting the shape of the frame appropriately allows a finished lens and a semi-finished lens to be directly manufactured.

It is preferable that the area surrounded by the frame is greater than the area of the plastic lens having undergone an edging process.

In this case, since the frame is formed to be larger than the area of the plastic lens having undergone the edging process, the degree of freedom in the edging process increases and the edging process can be carried out in a variety of ways. For example, the invention is applicable to ophthalmic lenses having a typical shape, a crab-eye shape, and a variety of other lens shapes.

It is preferable that after the frame is formed on the surface of at least one of the pair of dies, the pair of dies are pressed against each other with the frame therebetween to form the space.

In this case, since after the frame is formed on at least one of the dies, the pair of dies are pressed against each other with the frame therebetween, the space into which the polymerizable composition is injected can be readily formed.

It is preferable that the frame is formed of a string-like member.

The string-like member is preferably a member having proper shape retentiveness and adherence. For example, a thermoplastic elastmer, such as EPM and EPDM, is suitably used.

In this case, since the frame is formed of a string-like member, the frame can be very readily formed.

It is preferable that the frame is made of a hot melt material.

In this case, since the frame is made of a hot melt material, the viscoelasticity thereof can be readily adjusted and controlled by appropriately setting the temperature. The frame can thus be readily formed. Further, since no organic solvent is used with a hot melt material, no load will be imposed on the environment.

### BRIEF DESCRIPTION OF THE DRAWINGS

The invention will now be described with reference to the accompanying drawings, wherein like numbers reference like elements.

FIGS. 1A and 1B are schematic views showing a method for manufacturing a plastic lens according to related art.

FIG. 2 is a schematic view showing formation of a frame 2 according to a first embodiment.

FIG. 3 is a schematic view showing the formed frame 2 according to the first embodiment.

FIGS. 4A to 4C are schematic views showing assembly of a molding die according to the first embodiment.

FIG. 5 is a schematic view showing injection of a polymerizable composition into the molding die according to the first embodiment.

FIG. 6 is a schematic side view showing the molding die with the polymerizable composition injected therein according to the first embodiment.

FIG. 7 is a flowchart showing a method for manufacturing a plastic lens according to the first embodiment.

FIGS. 8A to 8C are schematic views showing polymerizable composition injection and molding die assembly according to a second embodiment.

FIG. 9 is a flowchart showing a method for manufacturing a plastic lens according to the second embodiment.

FIG. 10 is a schematic view showing formation of the frame 2 according to a third embodiment.

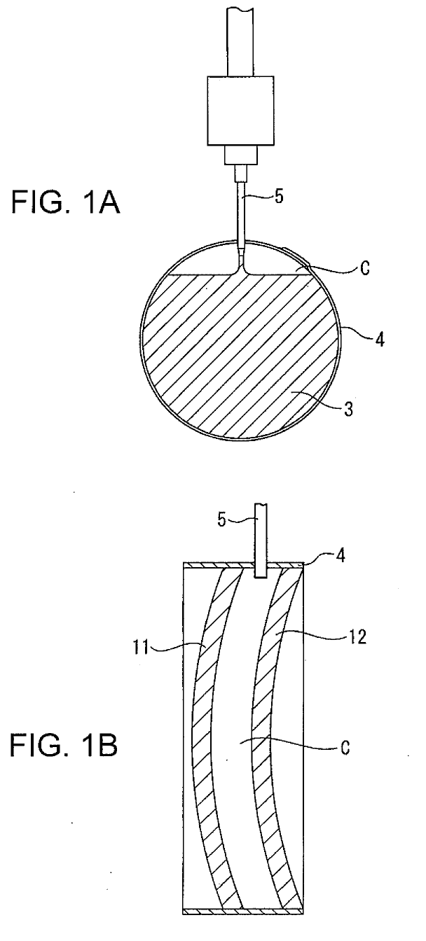

### DESCRIPTION OF EXEMPLARY EMBODIMENTS

### First Embodiment

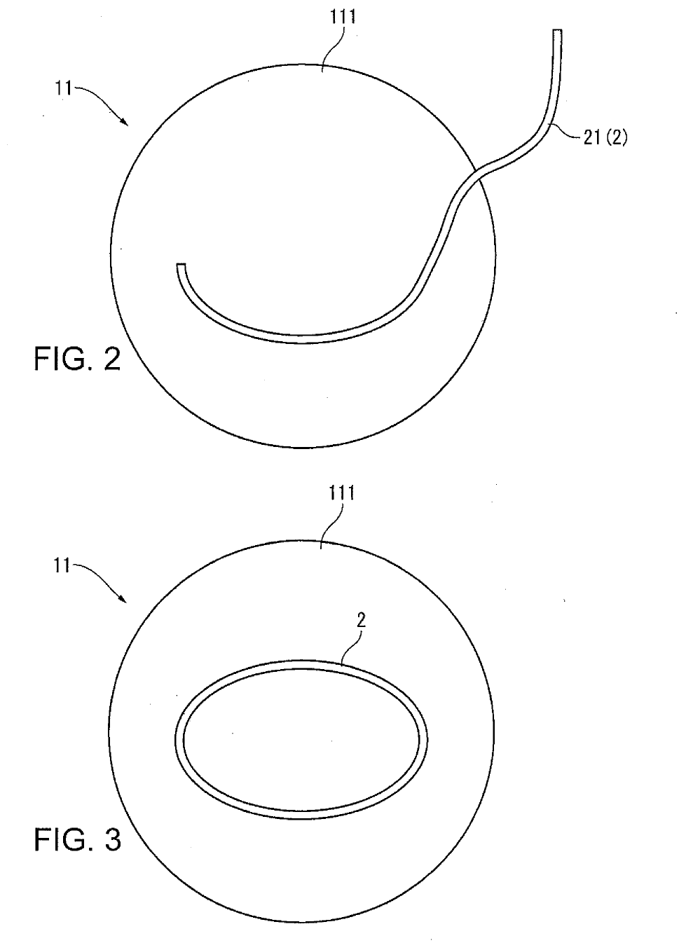

A method for manufacturing an ophthalmic plastic lens (hereinafter sometimes simply referred to as a “lens”) will be described in summary with reference to FIGS. 2 to 7.

### Frame Formation

FIG. 2 is a schematic view showing formation of a frame 2 according to the present embodiment. FIG. 3 is a schematic view showing the formed frame 2 in the first embodiment.

First, a cleaned concave die 11 having a surface for molding a convex surface of a lens 111 is prepared, as shown in FIGS. 2 and 3. The frame 2 is formed on the convex-surface molding surface 111 by placing a string-like member 21 on the convex-surface molding surface 111 and shaping the string-like member 21 into a predetermined form. In this process, a hole (not shown) is provided in the frame 2. The diameter of the string-like member is selected in agreement with the thickness of the plastic lens. The string-like member is obtained by shaping a thermoplastic elastmer having proper shape retentiveness and adherence, such as EPM and EPDM, into a string.

### Assembly of Molding Die

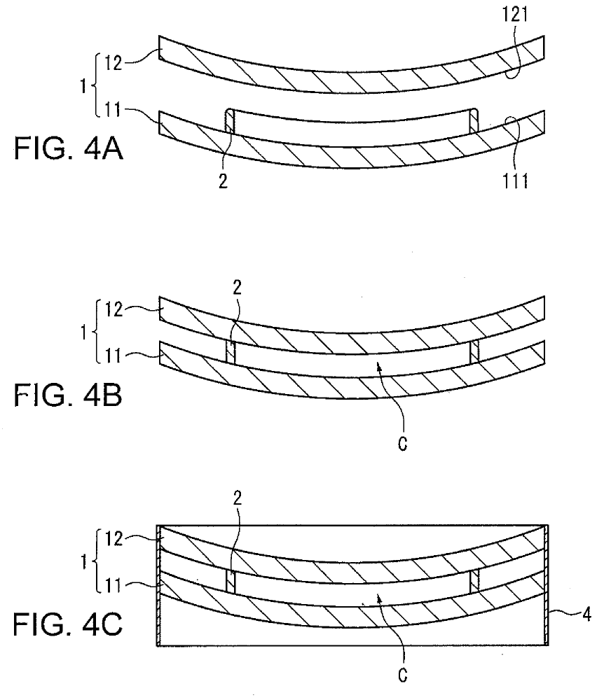

FIGS. 4A to 4C are schematic views showing assembly of a molding die according to the present embodiment. As shown in FIG. 4A, the convex-surface molding surface 111 of the concave die 11 and a concave-surface molding surface 121 of a convex die 12 are disposed in such a way that they face each other and sandwich the frame 2 formed on the surface of the concave die 11.

Thereafter, the pair of dies 1 (the concave die 11 and the convex die 12) are pressed against each other with the frame 2 therebetween so that the dies 1 are spaced apart from each other by a predetermined distance, as shown in FIG. 4B. Therefore, the frame 2 sandwiched between the concave die 11 and the convex die 12 is slightly compressed and comes into contact with the concave die 11 and the convex die 12.

Thereafter, an adhesive tape 4 is placed along the circumferential side surfaces of the dies 1 facing each other, as shown in FIG. 4C. Placing the adhesive tape 4 over the circumferential side surfaces of the concave die 11 and the convex die 12 allows the concave die 11 and the convex die 12 to be secured.

### Injection of Polymerizable Composition

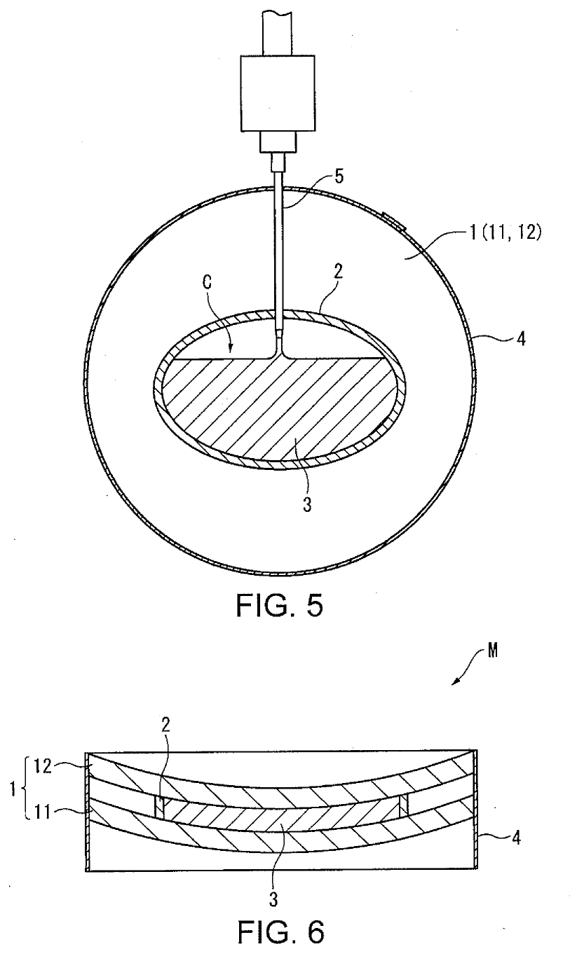

FIG. 5 is a schematic view showing injection of a polymerizable composition into the molding die according to the present embodiment. FIG. 6 is a schematic side view showing the molding die with the polymerizable composition injected therein.

As shown in FIG. 5, a raw material injecting needle 5 injects a polymerizable composition 3 into a space C surrounded by the convex-surface molding surface 111 of the die 11, the concave-surface molding surface 121 of the die 12 (the convex-surface molding surface 111 and the concave-surface molding surface 121 face each other), and the frame 2.

In the injection process, the raw material injecting needle 5 is first inserted through the hole provided at a predetermined position in the frame 2. The polymerizable composition 3 is then pushed out of the raw material injecting needle 5 into the space C so that the space C is filled with the polymerizable composition 3. The injection is thus completed and then the hole is shielded.

### Polymerization of Polymerizable Composition

After the polymerizable composition 3 is injected, the injected polymerizable composition 3 is polymerized (cured) by exposing the molding die M to an environment in which the temperature and time are set to predetermined values, as shown in FIG. 6. In this process, the molding die M is preferably placed in a horizontal position so that the concave die 11 is lower than the convex die 12.

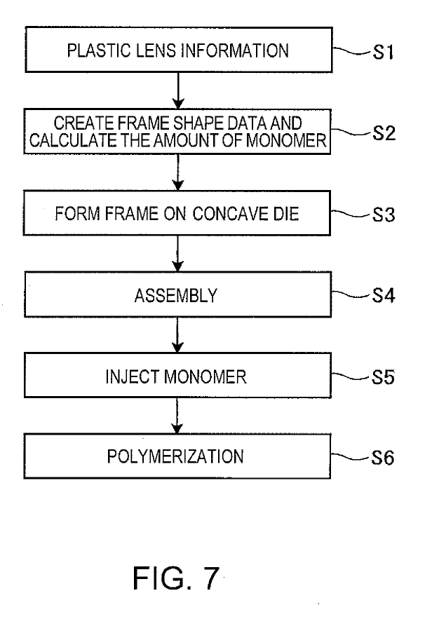

The above manufacturing method will be described more specifically with reference to the flowchart in FIG. 7 and FIGS. 2 to 6. The flowchart in FIG. 7 shows the method for manufacturing a lens in the present embodiment.

First, lens information is inputted to a predetermined information processor (hereinafter referred to as S1 or step 1). The lens information may include the spherical diopter, astigmatic diopter, astigmatism axis, addition power, lens thickness, interpupillary distance, fitting point, and frame shape.

Information processing is carried out based on the information inputted in S1 to calculate data on the shape of the frame 2 and the amount of the polymerizable composition 3, select the convex die 12, and calculate the positions where the concave die 11 and the convex die 12 are disposed to face each other (hereinafter referred to as S2 or step 2).

Specifically, the frame shape is used to calculate the shape of the frame 2. In this process, the frame 2 is formed into a circular shape greater than a target lens preferably by approximately a few millimeters, more preferably, approximately 2 to 3 millimeters.

The fitting point is used to determine where the frame 2 is formed on the concave die 11 (see FIGS. 2 and 3). Further, an optimum die is selected from multiple types of convex dies 12 and the angle, the position, and the distance used when the concave die 11 and the convex die 12 are disposed to face each other are determined based on the astigmatic diopter, the astigmatic axis, and the lens thickness. (see FIGS. 4A to 4C).

After S2, the following operations are carried out as described above: The frame is formed on the concave die 11 (hereinafter referred to as S3 or step 3). The convex die 12 is overlaid to assemble the molding die M (hereinafter referred to as S4 or step 4). The polymerizable composition 3 is infected into the space C (hereinafter referred to as S5 or step 5). The polymerizable composition 3 is polymerized (cured) to provide a plastic lens (hereinafter referred to as S6 or step 6).

The preparation of the polymerizable composition 3 will be described.

The polymerizable composition 3 is prepared by mixing a monomer compound with a curing catalyst and other constituents in a raw material mixing tank (not shown).

The mixing tank is preferably equipped with an apparatus capable of cooling the polymerizable composition 3 placed therein to prevent the highly polymerizable composition 3 from polymerizing, and the mixing operation is preferably carried out by keeping the polymerizable composition 3 at a temperature lower than 21° C.

The temperature at which the mixing operation is carried out preferably ranges from −30° C. to 20° C., particularly from −10° C. to 19° C. These temperature ranges prevent the polymerization reaction from occurring in the mixing operation and allow uniform polymerization in the molding die M.

Alternatively, the polymerizable composition 3 may be heated to a fixed temperature for a predetermined period to increase the viscosity. The viscosity control reduces the chance of leakage of the polymerizable composition 3 from the frame 2, whereby the polymerizable composition 3 is readily handled in the manufacturing processes.

The polymerizable composition 3 having undergone the mixing operation is preferably kept at a temperature lower than 21° C. before injected into the molding die M. The polymerizable composition 3 can be kept at a temperature lower than 21° C. by storing it in a storage container capable of adjusting the temperature therein to a fixed value lower than 21° C. Setting the storage temperature to a value ranging from −30° C. to 20° C., particularly from −10° C. to 19° C., allows the heat of polymerization to be removed and prevents the polymerization reaction from rapidly proceeding.

Accordingly, the present embodiment provides the following advantages:

1. Since the concave die 11 and the convex die 12 sandwiches the frame 2 to form the space C, the volume of the space C can be smaller than that in a case where no frame 2 is provided.

The necessary amount of polymerizable composition 3, which is the raw material, can thus be reduced. As a result, not only can the plastic lens manufacturing cost be lowered, but also the amount of waste can be reduced, which is also desirable from the viewpoint of environment protection.

Further, since the frame 2 allows the shape of the space C to be arbitrarily set, the plastic lens can be readily formed into a desired shape. For example, selecting the shape of the frame appropriately allows a finished lens and a semi-finished lens to be directly manufactured.

2. Since the frame 2 is formed into a circular shape greater than a target plastic lens by approximately a few millimeters, the plastic lens can be processed in a variety of ways. For example, the present embodiment is applicable to ophthalmic lenses having a typical shape, a crab-eye shape, and a variety of other lens shapes.

When the frame 2 is shaped to be larger than a target plastic lens by approximately 2 to 3 mm, the consumption of the polymerizable composition 3 can be further reduced while the plastic lens can still be processed in a variety of ways.

3. A plastic lens can be readily formed by simply carrying out the following operations: The frame 2 is formed on the concave die 11. The concave die 11 and the convex die 12 are disposed to face each other. The adhesive tape 4 secures the circumferential side surfaces of the dies to form the molding die M. The polymerizable composition 3 is injected into the molding die M.

Further, since the frame 2 is formed on the concave die 11, the fitting point can be determined only by changing the position of the frame 2 on the concave die 11.

Moreover, the shape of the convex die 12 and the angle, the position, and the distance used when the convex die 12 and the concave die 11 are disposed to face and overlaid on each other can be used to readily determine the astigmatic diopter, the astigmatic axis, and the lens thickness.

4. Since the string-like member 21 is used as the frame 2, a general-purpose member can be used to form the frame 2. For example, a thermoplastic elastmer, such as EPM and EPDM, is preferably used.

### Second Embodiment

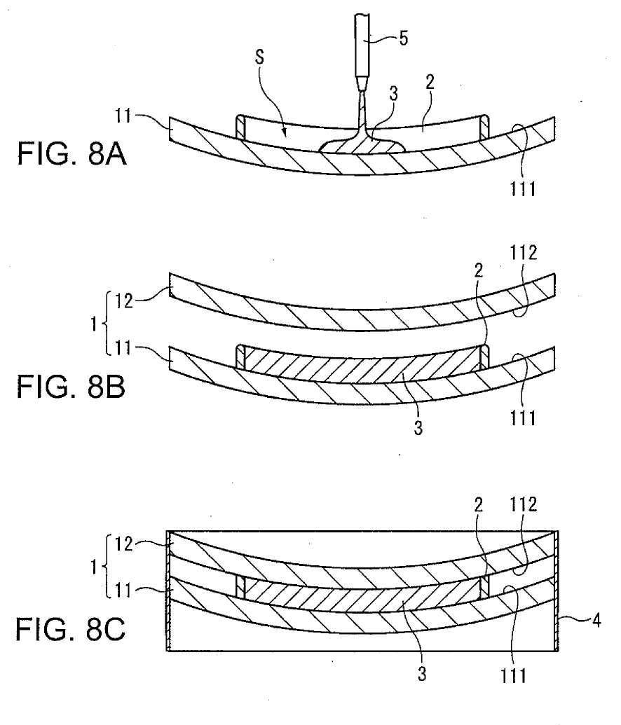

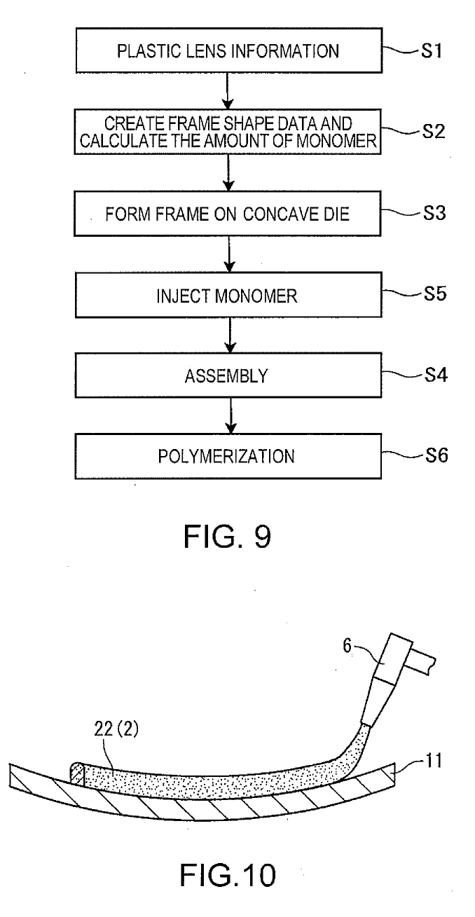

A method for manufacturing a plastic lens according to a second embodiment will be described with reference to FIGS. 8A to 8C and 9. FIGS. 8A to 8C are schematic views showing polymerizable composition injection and molding die assembly according to the second embodiment. FIG. 9 is a flowchart showing the method for manufacturing a plastic lens according to the second embodiment.

As shown in FIGS. 8A to 8C, the frame 2 is formed on the concave die 11, as in the case of the first embodiment, and the polymerizable composition 3 is injected from the raw material injecting needle 5 into a circular space S surrounded by the frame 2.

After the space S is filled with the polymerizable composition 3, the concave die 11 and the convex die 12 are disposed to face each other. Thereafter, the adhesive tape 4 is wound around the circumferential side surfaces of the concave die 11 and the convex die 12 to secure the dies 1. The molding die M is thus formed.

In the present embodiment, the polymerizable composition 3 is injected before the molding die M is assembled, as shown in FIG. 9.

Accordingly, the present embodiment provides the following advantage as well as those described in the items 1 to 4.

5. Since the polymerizable composition 3 is injected into the space S before the concave die 11 and the convex die 12 are disposed to face each other, the polymerizable composition 3 can be readily injected without having to provide a hole in the frame 2 to insert the raw material injecting needle 5.

### Third Embodiment

A method for manufacturing a plastic lens according to a third embodiment will be described with reference to FIG. 10. FIG. 10 is a schematic view showing formation of the frame 2 according to the third embodiment.

As shown in FIG. 10, the frame 2 is made of a hot melt material 22. A hot melt gun 6 is used to form the hot melt material 22 on the concave die 11.

In this process, it is preferable to raise the height of the hot melt material 22 or lower the height by pressing the hot melt material 22 in accordance with the thickness of a target plastic lens. Except the above operation, the plastic lens is manufactured in the same manner as in the other embodiments.

Accordingly, the present embodiment provides the following advantage as well as those described in the items 1 to 3 and 5.

6. Since the frame 2 is made of the hot melt material 22, the frame can be made of a general-purpose material. Using the hot melt material 22 also allows the viscosity thereof to be readily adjusted and controlled by appropriately setting the temperature. The frame 2 can thus be readily formed.

Further, since no organic solvent is used with a hot melt material, no load will be imposed on the environment.

While the best configuration, method, and other factors for carrying out the invention have been disclosed in the above description, the invention is not limited thereto.

While a thermoset resin is used as the polymerizable composition 3 in the first to third embodiments, the polymerizable composition 3 may be replaced with a photo-setting resin, which is polymerized and cured when the molding die M is irradiated with light.

While a hole for injecting the polymerizable composition 3 is provided when the frame 2 is formed in the first embodiment, the hole is not necessarily provided this way. For example, no hole is provided when the frame 2 is formed, but a hole may be provided by drilling the frame 2 when the polymerizable composition 3 is injected.

The string-like member 21 is used as the frame 2 in the first and second embodiments, and the hot melt material 22 is used in the third embodiment. The frame 2 is not necessarily made of the string-like member 21 or the hot melt material 22, but may be made of any other suitable resin material.

The frame 2 is formed on the concave die 11 and the polymerization and curing is carried out with the concave die 11 placed in the lower position in the first to third embodiments. Alternatively, the frame 2 may be formed on the convex die 12 and the polymerization and curing is carried out with the convex die 12 placed in the lower position.

The invention is preferably applicable to a method for manufacturing not only an ophthalmic plastic lens but also dustproof glass, dustproof quartz, a condenser lens, a prism, and other optical lenses.

The entire disclosure of Japanese Patent Application No: 2008-297676, filed Nov. 21, 2008 is expressly incorporated by reference herein.

What is claimed is:

1. A method for manufacturing a plastic lens, the method comprising:
disposing a pair of plastic lens molding dies in such a way that the dies face each other and are spaced apart from each other by a predetermined distance;
forming a frame between the pair of dies;
injecting a polymerizable composition into the space surrounded by the frame and the pair of dies; and
polymerizing the polymerizable composition in the space to form a plastic lens.

2. The method for manufacturing a plastic lens according to claim 1,
wherein the area surrounded by the frame is greater than the area of the plastic lens having undergone an edging process.

3. The method for manufacturing a plastic lens according to claim 1,
wherein after the frame is formed on the surface of at least one of the pair of dies, the pair of dies are pressed against each other with the frame therebetween to form the space.

4. The method for manufacturing a plastic lens according to claim 1,
wherein the frame is formed of a string-like member.

5. The method for manufacturing a plastic lens according to claim 1,
wherein the frame is made of a hot melt material.
